(19) United States
(12) Patent Application Publication
(10) Pub. No.: US 2024/0201440 A1
(43) Pub. Date: Jun. 20, 2024

(54) LOW-LOSS OPTICAL BENT WAVEGUIDE CORE

(71) Applicant: IMEC VZW, Leuven (BE)

(72) Inventor: Qingzhong Deng, Oud-Heverlee (BE)

(21) Appl. No.: 18/541,931

(22) Filed: Dec. 15, 2023

(30) Foreign Application Priority Data
Dec. 16, 2022 (EP) EP 22214181.4

(51) Int. Cl. G02B 6/125

(52) U.S. Cl. CPC G02B 6/125

(57) ABSTRACT

A waveguide core bent according to a certain curve or family of curves is provided. In one aspect, the waveguide core has a smooth curve as an edge and/or centerline of the waveguide core, wherein a curvature of the smooth curve is continuous and the first order derivative of the curvature of the smooth curve with respect to an arc length of the smooth curve is continuous. The smooth curve includes a curve start point and a curve end point, wherein the derivative of the curvature of the smooth curve is zero at the curve start point and at the curve end point. The curvature of the smooth curve is zero at the curve start point, and is non-zero or zero at the curve end point.

### CROSS-REFERENCE TO RELATED APPLICATIONS

This application claims foreign priority to European Application No. EP 22214181.4, filed on Dec. 16, 2022, the content of which is incorporated by reference herein in its entirety.

### BACKGROUND

### Field

The disclosed technology relates to waveguides, particular to a waveguide core. The waveguide core can be bent according to a smooth curve or a family of smooth curves.

### Description of the Related Technology

When light propagates in a bent waveguide core, the center of the optical modes of the light may be shifted towards a waveguide core's outer boundary due to the bending. Generally, the smaller the bending curvature of the waveguide core is, the larger the shift of the optical mode center is. The shift may result in mode transition loss when connecting two waveguide cores with different curvatures, or, for example, if a waveguide core includes a connection between a straight waveguide core segment and a bent waveguide core segment (that is, it includes a straight-bent waveguide core transition). To reduce the mode transition loss, conventional bent waveguide cores may be bent according to an Euler curve (see FIG. 3), but better solutions are still needed.

### SUMMARY OF CERTAIN INVENTIVE ASPECTS

In view of the above, one objective of the disclosed technology is to reduce loss in a waveguide core that includes at least one bent waveguide core segment. In particular, an objective is to reduce a loss caused by connections of different segments of the waveguide core, for example, segments of different curvature. Another objective of the disclosed technology is to improve the energy efficiency of thermo-optic phase shifters applied to such waveguide cores.

These and other objectives can be achieved by embodiments of the disclosed technology.

A first aspect of the disclosed technology provides a waveguide core having a smooth curve as an edge and/or centerline of the waveguide core. A curvature of the smooth curve is continuous and the first order derivative of the curvature of the smooth curve with respect to an arc length of the smooth curve, for example, an entire arc length of the smooth curve, is continuous. The smooth curve includes a curve start point and a curve end point. The derivative of the curvature of the smooth curve is zero at the curve start point and at the curve end point. The curvature of the smooth curve is zero at the curve start point, and is non-zero or zero at the curve end point.

The bent waveguide core of the first aspect can reduce loss in the waveguide core, in particular, if the waveguide core has segments of different curvature and/or has also straight segments. For example, the waveguide core may be configured to minimize the mode transition loss.

The curvature of the smooth curve may be not always zero.

The curvature κ of the smooth curve may be defined by the transition of the tangential angle θ of the smooth curve, for example, along the arc length of the smooth curve, for example, along the entire arc length of the smooth curve. The curvature of the smooth curve may have a continuous transition of the tangential angle.

The tangential angle difference between the curve start point and the curve end point may be less than π.

The waveguide core may further have one or more other smooth curves as one or more other edges of the waveguide core.

The waveguide core may further have one or more other smooth curves as one or more baseline curves. Each baseline curve may be parallel to an edge of the waveguide core and/or to a smooth curve associated with the edge, for example, along an arc length of a curve segment of the smooth curve or along an entire arc length of the smooth curve.

In some embodiments of the first aspect, the smooth curve includes a curve segment, wherein the curve segment includes a start point of the curve segment and an end point of the curve segment. The derivative of the curvature of the smooth curve is zero at the start point of the curve segment and is zero at the end point of the curve segment. The curvature of the smooth curve is zero at the start point of the curve segment and is non-zero at the end point of the curve segment.

Thus, for example, the loss in the waveguide core at one or more connection points between one or more segments included in the smooth curve and/or between other waveguide cores connectable to the waveguide core may be reduced. This may be achieved, because the first order derivative of the curvature of the smooth curve with respect to the arc length of the smooth curve is continuous.

The curvature of the smooth curve in the curve segment may be according to and/or may be defined by a third order, or larger order, polynomial function.

The end point of the curve segment may be the curve end point. Alternatively, the start point of the curve segment may be the curve start point. Alternatively, the end point of the curve segment may not be the curve end point, and the start point of the curve segment may not be the curve start point.

In some embodiments of the first aspect, a Cartesian coordinate system is defined with the start point of the curve segment as its origin. The x-axis and y-axis are defined to have the end point of the curve segment in the first quadrant, and a tangential angle of zero radian at the start point of the curve segment. The tangential angle, for example in the unit of radian, of any point P on the curve segment is

$$θ ( s ) = \frac{4 {κ}_{e}^{3} {θ}_{e} {s}^{3} - {κ}_{e}^{4} {s}^{4}}{16 {θ}_{e}^{3}} ,$$

wherein s is the length of the arc length of the smooth curve from the start point of the curve segment to a point P, κₑ is the curvature at the end point of the curve segment, and θₑ is the tangential angle at the end point of the curve segment.

In some embodiments of the first aspect, the curve segment of the smooth curve is parallel to a baseline curve. The baseline curve includes a start point of the baseline curve and an end point of the baseline curve. A Cartesian coordinate system is defined with the start point of the baseline curve as its origin. The x-axis and y-axis are defined to have the end point of the baseline curve in the first quadrant, and a tangential angle of zero radian at the start point of the baseline curve. The tangential angle, for example in the unit of radian, of any point P on the baseline curve is

$$θ ( s ) = \frac{4 {κ}_{e}^{3} {θ}_{e} {s}^{3} - {κ}_{e}^{4} {s}^{4}}{16 {θ}_{e}^{3}} ,$$

wherein s is the length of the arc length of the smooth curve from the start point of the baseline curve to a point P, κₑ is the curvature at the end point of the baseline curve, and θₑ is the tangential angle at the end point of the baseline curve.

In some embodiments of the first aspect, the smooth curve further includes a straight segment, wherein the straight segment includes a start point of the straight segment and an end point of the straight segment. The end point of the straight segment is connected to the start point of the curve segment.

The start point of the straight segment may be the curve start point.

In some embodiments of the first aspect, the smooth curve further includes a circular segment, wherein a curvature of the circular segment is constant. The curvature of the circular segment is equal to the curvature of the smooth curve at the end point of the curve segment. The circular segment includes a start point of the circular segment and an end point of the circular segment. The end point of the curve segment is connected to the start point of the circular segment.

The end point of the circular segment may be or may not be the curve end point.

In some embodiments the first aspect, the curve segment is a first curve segment and the smooth curve further includes a second curve segment according to the first curve segment, wherein the curvature at the end point of the first curve segment is the same as the curvature at the end point of the second curve segment. The end point of the first curve segment is connected to the end point of the second curve segment, or the end point of the circular segment is connected to the end point of the second curve segment.

The curvature of the smooth curve in the second curve segment may be according to and/or defined by a third order or larger order polynomial function. The function may or may not be the same function that may define the curvature of the smooth curve in the first curve segment.

The second curve segment may be mirrored to the first curve segment.

The second curve segment may be line symmetric to the first curve segment regarding a perpendicular bisector of the smooth curve along its arc length between the second curve segment and the first curve segment.

The end point of the second curve segment may be or may not be the curve end point.

The straight segment may be a first straight segment.

The smooth curve may further include a second straight segment. The second straight segment may include a start point of the second straight segment and an end point of the second straight segment, wherein the start point of the second straight segment may be connected to the end point of the second curve segment. The end point of the second straight segment may be the curve end point.

In some embodiments of the first aspect, the waveguide core has a first smooth curve as an inner edge and/or centerline of the waveguide core, and has a second smooth curve as an outer edge of the waveguide core.

The first smooth curve may be a smooth curve according to embodiments of the first aspect. The second smooth curve may be a smooth curve according to embodiments of the first aspect.

A curvature of the waveguide core may define an inner edge of the waveguide core, and the curvature of the waveguide core may also define an outer edge of the waveguide core. For example, the inner edge of the waveguide core may be shorter due to a curvature of the waveguide core, and the outer edge of the waveguide core may be longer due the curvature of the waveguide core. The curvature of the waveguide core may refer to how the waveguide core is bent.

For example, the inner edge may be an edge that follows a shortest path, along the longitudinal extension of the waveguide core, from a start cross section of the waveguide core to an end cross section of the waveguide core. The outer edge may be an edge that follows a longest path, along the longitudinal extension of the waveguide core, from the start cross section of the waveguide core to the end cross section of the waveguide core.

The waveguide core may further have one or more other smooth curves as one or more other edges of the waveguide core.

For example, the waveguide core may be a core of a slot waveguide or a core of a rib waveguide. The first edge, the second edge, and the one or more other edges may be defined along the longitudinal extension of the waveguide core and/or may define the waveguide core.

In general, all edges of the waveguide core may refer to edges along the longitudinal extension of the waveguide core.

In some embodiments of the first aspect, the first smooth curve and the second smooth curve are parallel to each other.

The first smooth curve may be parallel to the second smooth curve along the longitudinal extension of the waveguide core, for example, along the entire longitudinal extension of the waveguide core. Thus, the waveguide core may have a same width along the longitudinal extension, for example length, of the waveguide core.

The constant width along the longitudinal extension of the waveguide core may be adjusted such that the waveguide core has optimized properties, for example low loss.

In some embodiments of the first aspect, the first smooth curve and the second smooth curve are not parallel to each other.

The first smooth curve may be nonparallel to the second smooth curve along the longitudinal extension of the waveguide core. Thus, the waveguide core may have a varying width along the longitudinal extension, for example length, of the waveguide core.

The varying width along the longitudinal extension of the waveguide core may be adjusted such that the waveguide core has optimized properties, for example low loss and/or excites a whispering gallery mode (WGM).

In some embodiments of the first aspect, the waveguide core is configured to be thermally connectable to a thermo-optic phase shifter in at least a portion of the inner boundary of the waveguide core.

Alternatively or additionally, the waveguide core may be configured to be electrically connectable to a thermo-optic phase shifter in at least the portion of the inner boundary of the waveguide core.

The term “thermally connectable” may refer to being directly thermally connected or connectable. Two components being “thermally connectable” may include that the components may be in direct physically contact and/or attached to each other. For example, the components may be directly adjacent to each other. The term “thermally connectable” may not include only being connected by gas molecules and/or radiation. The term “thermally connectable” may refer to two solid components that may be in direct physical contact with each other, wherein the contact allows for direct heat transfer. For example, electrical wires can be connected to deliver current through for heating generation. The electrical wires can be metal, such as Cu and Al, etc., or doped semiconductor, such as Si and Ge, etc.

The portion of the inner boundary of the waveguide core may be in, and/or may be associated with, and/or may correspond to, a portion of the circular segment of the smooth curve.

Additionally or alternatively, the portion of the inner boundary of the waveguide core may be in, associated with, and/or correspond to a portion of the first curve segment and/or the second curve segment of the smooth curve, for example, if the smooth curve does not include a circular section or if the circular section is too small for thermally connecting the thermo-optic phase shifter to the waveguide core.

The thermo-optic phase shifter may include a heater, wherein the heater may be thermally connectable to the waveguide core in at least the portion of the inner boundary of the waveguide core.

In some embodiments of the first aspect, a sidewall of the waveguide core facing towards the thermo-optic phase shifter in the at least the portion of the inner boundary is configured to be open for the thermo-optic phase shifter.

For example, a side wall of the waveguide core may be open and/or removed in a portion of the waveguide core.

Thus, the thermo-optic phase shifter may be applied more efficiently to the waveguide core.

The at least the portion of the inner boundary may be configured to be open for the thermo-optic phase shifter, as the waveguide core is configured to excite a WGM. Thus, the waveguide core can be partially opened without increasing the loss of the waveguide core.

In some embodiments of the first aspect, a centerline of the waveguide core along the longitudinal extension of the waveguide core, for example, along an entire longitudinal extension of the waveguide core, defines a plane, and the inner edge of the waveguide core and the outer edge of the waveguide core are in the plane along the longitudinal extension of the waveguide core.

In some embodiments of the first aspect, the waveguide core is configured to excite a whispering gallery mode.

Thus, the energy efficiency of the thermo-optic phase shifter applied to the waveguide core can be increased.

The waveguide core may be configured to primarily excite a WGM and secondly minimize the loss of the waveguide core.

The waveguide core may have a minimized loss, for example, transition loss, based on configuring the edges and/or centerline of the waveguide core and/or the smooth curves associated with the edges and/or centerline.

Further, in this disclosure the phrases “after” and “before” when referring to the smooth curve may correspond to a direction from the curve start point to the curve end point. Thus, the curve start point is positioned before the curve end point and the curve end point is positioned after the curve start point.

Further, in this disclosure a top view may refer to a top view or a bottom view of a plane including the longitudinal extension direction of the waveguide core. The plane may be defined by and/or include the inner edge and the outer edge of the waveguide core. The top view and the bottom view of the plane may be mirrored.

### BRIEF DESCRIPTION OF THE DRAWINGS

The above-described aspects and implementation forms will be explained in the following description of specific embodiments in relation to the enclosed drawings.

FIG. 1 shows an exemplary waveguide core according to an embodiment of the disclosed technology.

FIG. 2A shows a smooth curve according to an embodiment of the disclosed technology and a curve with a conventional circular bend.

FIG. 2B shows respective smooth curves for different θ_{c} values for waveguide cores according to an embodiment of the disclosed technology.

FIG. 2C shows a waveguide core having constant width according to an embodiment of the disclosed technology.

FIG. 2D shows a waveguide core according to an embodiment of the disclosed technology having a varying width along its longitudinal extension.

FIG. 3A shows two waveguide cores with constant width according to an embodiment of the disclosed technology and two conventional waveguide cores with constant width.

FIG. 3B shows a conventional waveguide core with varying width and a waveguide core with varying width according to an embodiment of the disclosed technology.

FIG. 3C shows a respective measured insertion loss for exemplary waveguide cores with constant width according to an embodiment of the disclosed technology.

FIG. 3D shows a respective measured insertion loss for exemplary waveguide cores with varying width according to an embodiment of the disclosed technology.

FIG. 4 shows a top-view of a thermo-optic phase shifter for regulating a temperature of a waveguide core that is configured to excite a WGM according to an embodiment of the disclosed technology.

FIG. 5 shows an energy efficiency comparison of a conventional Tungsten (W) heater and a WGM-based heater according to an embodiment of the disclosed technology.

### DETAILED DESCRIPTION OF CERTAIN ILLUSTRATIVE EMBODIMENTS

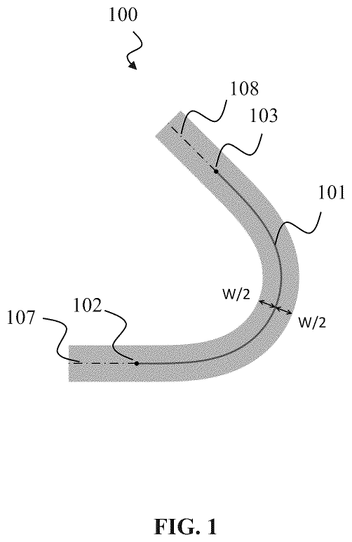

FIG. 1 shows an exemplary waveguide core 100 according to an embodiment of the disclosed technology. The waveguide core 100 has a smooth curve 101 as an edge and/or centerline of the waveguide core 100 (here an exemplary smooth curve 101 is illustrated). For example, the waveguide core 100 may have a respective smooth curve 101 as its one or more edges and/or a centerline. The respective edge and/or centerline of the waveguide core 100 may be associated with, may correspond to, and/or may define the smooth curve 101. The smooth curve includes a curve start point 102 and a curve end point 103.

In general, a curvature of the smooth curve 101 is continuous, and the first order derivative of the curvature of the smooth curve 101 with respect to an arc length of the smooth curve 101 is continuous. The derivative of the curvature of the smooth curve 101 is zero at the curve start point 102 and at the curve end point 103. The curvature of the smooth curve 101 is zero at the curve start point 102, and is non-zero or zero at the curve end point 103.

The exemplary waveguide core 100 shown in FIG. 1 has a smooth curve 101 as a centerline. For example, the distance from the centerline of the waveguide core 100 to respectively an inner edge and an outer edge of the waveguide core 100 may be W/2 (as indicated in FIG. 1), where W may be a width of the waveguide core 100. In this example, the inner and outer edges and the centerline smooth curve 101 have the same curvature, because the waveguide core width is constant along the longitudinal extension of the waveguide core 100.

Further, FIG. 1 shows that the waveguide core 100 may also have two straight segments 107, 108, which are indicated as dot-dashed lines. One straight segment 107 may be positioned before the curve start point 102, and the other straight segment 108 may be positioned after the curve end point 103. In this example, the two straight segments 107, 108 are not part of the smooth curve 101. Alternatively, however, the exemplary straight segments 107, 108 shown in FIG. 1 could be included in the smooth curve 101. In this case, the curve start point 102 and the curve end point 103 would be at a different position than shown on FIG. 1. The curve start point 102 would be at a start point of one of the straight segments 107, and the curve end point 103 would be at an end point the other straight segment 108.

The waveguide core 100 may be connectable to and/or included in a waveguide. The waveguide core 100 may be connectable to, included in, surrounded by, and/or covered by a cladding. A waveguide may include the waveguide core 100 and a cladding surrounding the waveguide core 100.

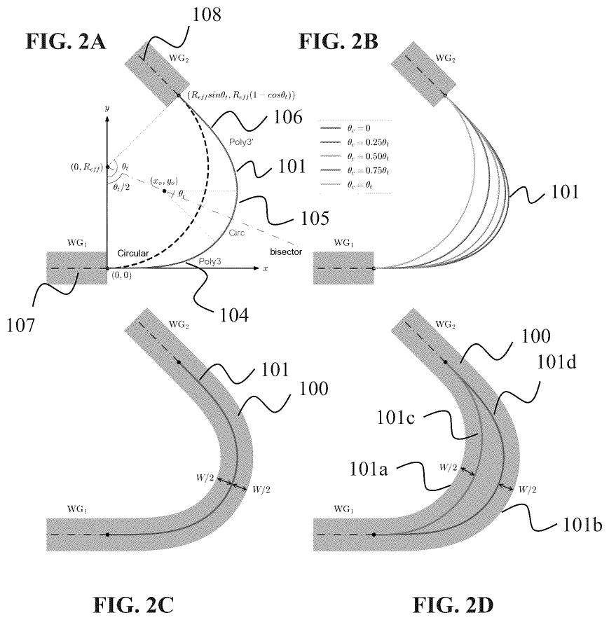

FIGS. 2A to 2D show exemplary smooth curves 101 for waveguide cores 100 according to embodiments of the disclosed technology. Any waveguide core 100 according to the disclosed technology may be used to replace a conventional circular bend for connecting arbitrarily two straight waveguides (WG₁ and WG₂).

FIG. 2A shows a smooth curve 101 for a waveguide core 100 according to an embodiment of the disclosed technology, and a conventional curve with a circular bend. The conventional curve is shown with a dashed line.

FIG. 2B shows respective smooth curves 101 for different θ_{c} values for waveguide cores 100 according to an embodiment of the disclosed technology. Each smooth curve 101 shown in FIG. 2B may be defined by a θ_{c} value. By adjusting the θ_{c} value, the smooth curve 101 and accordingly the waveguide core 100 may be adjusted.

FIG. 2C shows a waveguide core 100 having constant width according to an embodiment of the disclosed technology. This waveguide core 100 may have a smooth curve 100 as a centerline of the waveguide core 100. The width of the waveguide core 100 may be W (as indicated in FIG. 2C). The waveguide core 100 may be surrounded by a cladding (not shown).

FIG. 2D shows a waveguide core 100 according to an embodiment of the disclosed technology having a varying width along its longitudinal extension. The waveguide core 100 shown in FIG. 2D has a first smooth curve 101a and a second smooth curve 101b. The two smooth curves 101a and 101b respectively follow the inner edge and the outer edge of the waveguide core 100. Further, FIG. 2D shows a third smooth curve 101c and a fourth smooth curve 101d which are inside the waveguide core 100. The third smooth curve 101c may be a first baseline curve, and the fourth smooth curve 101d may be a second baseline curve. In particular, the third smooth curve 101c may correspond to the curvature of the inner edge of the waveguide core 100 and/or the first smooth curve 101a, and the fourth smooth curve 101d may correspond to the curvature of the outer edge of the waveguide core 100 and/or the second smooth curve. The inner edge and the outer edge may be defined with regards to the direction in which the waveguide core 100 is bent. Again, the waveguide core 100 may be surrounded by a cladding (not shown). The cladding may have the same thickness along the length of the waveguide core 100, for example, along the entire length of the waveguide core 100.

The third smooth curve 101c may run parallel to the inner edge of the waveguide core 100, for example, along the arc length of the first curve segment 104, and the fourth smooth curve 101b may run parallel to the outer edge of the waveguide core 100, for example, along the arc length of the first curve segment 104. For example, the third smooth curve 101c and the fourth smooth curve 101d may be offset respectively from the inner edge and the outer edge, for instance, with a distance of 3W/4 and W/4, or any other number or pair of numbers.

In an example, the smooth curve 101 of any waveguide core 100 of the disclosed technology may include, along the arc length of the smooth curve 101, the following in sequence: a first straight segment 107, a first curve segment 104, a circular segment 105, a second curve segment 106, and a second straight segment 108.

In another example, the smooth curve 101 of any waveguide core 100 of the disclosed technology may include, along the arc length of the smooth curve 101, in sequence a first straight segment 107, a first curve segment 104, a second curve segment 106, and a second straight segment 108. Thus, the smooth curve 101 may have zero curvature at the curve start point and the curve end point and the derivative of the curvature of the smooth curve 101 in the points may be zero.

In another example, the smooth curve 101 of any waveguide core 100 of the disclosed technology may include, along the arc length of the smooth curve 101, in sequence a first straight segment 107 and a first curve segment 104. Thus, the smooth curve 101 may have zero curvature at the curve start point and non-zero curvature at the curve end point, and the derivative of the curvature of the smooth curve 101 in the points may be zero.

For the following part of the description, a coordinate system is defined based on WG₁. FIG. 2A shows the center of the WG₁ end is the origin of the coordinate system, and the direction of WG₁ is the x-axis direction. (x₁, y₁)=(0, 0) and (x₂, y₂)=(R_{eff} sin θₜ, R_{eff}(1−cos θₜ)) are the two given points that can be connected by a smooth curve 101. Further, for the following part of the description, only y₂>0 is considered. Alternatively, for the case of y₂<0, the bend design can be done by first connecting to (x₂, −y₂) with the procedure described below, and then mirroring the generated bend with respect to x-axis to connect to (x₂,y₂).

Each smooth curve 101 may include a bend. The bend may define an entire curvature and/or an entire curved section of the smooth curve 101. For example, all curved parts of the smooth curve may be included and/or defined by the bend of the smooth curve. The smooth curve may further include or not include one or more straight segments 107, 108.

In general, the bend of each smooth curve 101 shown in FIGS. 2A to 2D may include three segments, labelled as Poly3 104, Circ 105, and Poly3′ 106. Circ 105 is a circular segment 105 with the curvature angle of θ_{c}, wherein θ_{c} may be limited by 0≤θ_{c}≤θₜ. When θ_{c}=0, the bend consists of Poly3 104 and Poly3′ 106 segments only and no circular segment 105. When θ_{c}=θₜ, the bend is the normal circular bend with a radius R_{eff}.

The curvature of the smooth curve 101 may be the first order derivative of the tangential angle along the arc length of the smooth curve.

The steps to generate a smooth curve 101 and/or a waveguide core 100, for example, a low loss bend waveguide core 100, may include:

### Step-1: Select the 3^{rd} Polynomial Function as a Base Curvature Function for Poly3:

$$κ ( s ) = {a}_{0} + {a}_{1} s + {a}_{2} {s}^{2} + {a}_{3} {s}^{3} \qquad ( 1 )$$

where κ=dθ/ds is the curvature, s is the curve length, and θ is a tangential angle along the smooth curve 101. θ can be expressed as:

$$θ ( s ) = {θ}_{0} + {\int }_{0}^{s} κ ( s ) d s = {θ}_{0} + {a}_{0} s + \frac{1}{2} {a}_{1} {s}^{2} + \frac{1}{3} {a}_{2} {s}^{3} + \frac{1}{4} {a}_{3} {s}^{4} \qquad ( 2 )$$

### Step-2: Set the Boundary Conditions for the Poly3 Segment 104:

θ is continuous. Similarly, a conventional circular bend would be continuous. Additionally, the κ transits gradually (that is, κ is continuous) and smoothly (that is, κ′=dκ/ds is continuous) at both connection points to the straight waveguides WG₁ and WG₂.

$$\{ \begin{matrix}θ {\vert}_{s = 0} = 0 \\ κ {\vert}_{s = 0} = 0 \\ {κ}^{′} {\vert}_{s = 0} = 0 \\ θ {\vert}_{s = L} = \frac{{θ}_{t} - {θ}_{c}}{2} \\ {κ}^{′} {\vert}_{s = L} = 0\end{matrix} \qquad ( 3 )$$

where L is the total length of the Poly3 segment 104, which is determined in Step-3. The continuity of κ at s=L is not included in this equation, which will be applied in Step-5.

Taking Equation (3) as the boundary conditions for Equation (1) and Equation (2), the curvature κ and the tangential angle θ can be expressed as:

$$\{ \begin{matrix}κ ( s , L ) = \frac{{θ}_{t} - {θ}_{c}}{{L}^{4}} ( 3 L {s}^{2} - 2 {s}^{3} ) \\ θ ( s , L ) = \frac{{θ}_{t} - {θ}_{c}}{{L}^{4}} ( L {s}^{3} - \frac{1}{2} {s}^{4} )\end{matrix} \qquad ( 4 )$$

The tangential angle θ expression can be re-written as

$$θ ( s ) = \frac{4 {κ}_{e}^{3} {θ}_{e} {s}^{3} - {κ}_{e}^{4} {s}^{4}}{16 {θ}_{e}^{3}}$$

when it is expressed with the curvature at the end point

$${κ}_{e} = \frac{{θ}_{t} - {θ}_{c}}{L} ,$$

and the tangential angle at the end point

$${θ}_{e} = \frac{{θ}_{t} - {θ}_{c}}{2} .$$

### Step-3: Calculate L:

The osculating circle center (xₒ, yₒ) at the endpoint of the Poly3 segment 104 can be expressed as the function of total length L of the Poly3 segment 104.

$$\{ \begin{matrix}{x}_{o} ( L ) = {\int }_{0}^{L} cos θ ( s , L ) ds - \frac{L}{{θ}_{t} - {θ}_{c}} sin \frac{{θ}_{t} - {θ}_{c}}{2} \\ {y}_{o} ( L ) = {\int }_{0}^{L} sin θ ( s , L ) ds + \frac{L}{{θ}_{t} - {θ}_{c}} cos \frac{{θ}_{t} - {θ}_{c}}{2}\end{matrix} \qquad ( 5 )$$

To connect the Poly3 segment 104 to the middle circular segment 105 Circ, (xₒ, yₒ) should be on the bisector of the bend angle θₜ, that is, L is the solution of the following equation:

$${x}_{o} ( L ) \cdot cos \frac{{θ}_{t}}{2} + ( {y}_{o} ( L ) - {R}_{eff} ) \cdot sin \frac{{θ}_{t}}{2} = 0 \qquad ( 6 )$$

### Step-4: Generate the Coordinates on the Poly3 Segment 104:

The coordinates on the Poly3 segment (x, y) can be generated by Eq. (7) where 0≤l≤L.

$$\{ \begin{matrix}x ( l ) = {\int }_{0}^{l} cos θ ( s , L ) ds \\ y ( l ) = {\int }_{0}^{l} sin θ ( s , L ) ds\end{matrix} \qquad ( 7 )$$

### Step-5: Generate the Coordinates on the Circ Segment 105:

The curvature of the Circ segment 105 may be chosen to be

$$\frac{{θ}_{t} - {θ}_{c}}{L}$$

so that the curvature is continuous at the connection point of the Poly3 segment 104 and the Circ segment 105. The Circ segment 105 may be circular with the radius of

$$R = \frac{L}{{θ}_{t} - {θ}_{c}} ,$$

the center of (xₒ, yₒ), the starting point of (x(L), y(L)), and the angle of θ_{c}.

### Step-6: Generate the Coordinates on the Poly3′ Segment 106:

The low-loss bend may be symmetric with respect to the bisector of the bend angle θₜ. The Poly3′ segment 106 may be generated by mirroring the Poly3 segment 104 with respect to the bisector of the bend angle θₜ.

### Step-7: Generate the Waveguide Core 100:

Given the value of θ_{c}, the smooth curve 101 connecting (0, 0) and (R_{eff} sin θₜ, R_{eff}(1−cos θₜ)) can be generated with Step-1 to Step-6. The generated smooth curve 101 may be controlled and/or adjusted by θ_{c} (0≤θ_{c}≤θₜ). The smaller the ↓_{c} is, the more the middle of the curve is shifted to the inner side of the bending (see FIG. 2B).

Step-1 to Step-6 may be used to generate the coordinates of a waveguide baseline curve 101c, 101d. The inner and/or outer edge of the waveguide core 100 may be generated as a parallel curve to the baseline curve 101c, 101d.

To generate a bent waveguide core with constant width of W, the inner and outer waveguide core edges or boundaries may be generated as a parallel curve with a distance of

$$\frac{W}{2}$$

to the waveguide core baseline curves 101c, 101d towards the inner and outer direction respectively (see FIG. 2C).

To generate a bent waveguide core 100 with varying width, two waveguide baseline curves 101c, 101d may be generated with different θ_{c} values which are used to generate the inner and outer edges respectively. For example, the inner and outer waveguide core edges or boundaries may be generated as a parallel curve with a distance of

$$\frac{W}{2}$$

to the waveguide core baseline curves 101c, 101d towards the inner and outer direction respectively (see FIG. 2D).

A low-loss bent waveguide core 100 may improve conventional integrated photonic systems. Embodiments of the disclosed technology provide a low-loss bent waveguide core 100, wherein the bending curvature changes gradually and smoothly. A waveguide core 100 bend, for example a poly3-circular bend, may be constructed with one adjustable parameter θ_{c} which can be used to lower the loss, for example, when a waveguide sidewall roughness exists.

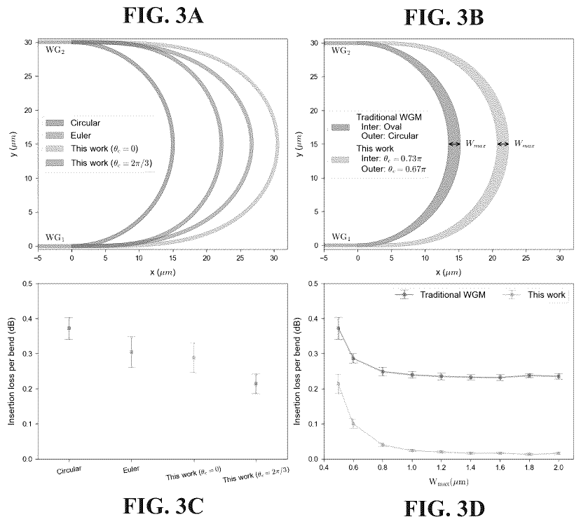

A curvature of a waveguide core 100 may transit gradually such that the transition loss is lowered. A waveguide core 100 according to an embodiment of the disclosed technology may have a waveguide core curvature κ transit not only gradually (that is, κ is continuous) but also smoothly (that is, κ′ is continuous). Conventional designs do not have a continuous κ′ during a straight-bent waveguide transition. The continuous κ′ may result in lower transition loss as shown in FIGS. 3A and 3C.

The coordinates of a straight-bent transition curve 101 may be determined by the base curvature function and the boundary conditions.
i) The boundary conditions of the waveguide core 100 may be configured such that the curvature derivative κ′ is continuous at straight-bent waveguide core connection points.
ii) The waveguide core 100 may include an optional circular segment 105 at the middle of bent waveguide which can reduce the bending loss (see FIGS. 2A and 2C).
iii) The waveguide core 100 may be configured to excite a WGM by giving the bend inner and outer edges different circular segment 105 angle θ_{c} (see FIGS. 2B and 2D).

Combining the transition curve design with waveguide core 100 widening during the transition can further reduce the loss.

The waveguide core 100 may have only one adjustable parameter. Thus, the waveguide core 100 may be easy to use in practical applications.

The waveguide core 100 may have lower loss than conventional waveguide cores 100, as the curve associated with the waveguide core 100 is smoother.

A waveguide core 100 according to the disclosed technology may be associated with a bend with arbitrary angle θ_{c} and/or the loss may be lower because the mode transition loss may be reduced.

FIGS. 3A to 3D show multiple exemplary waveguide cores 100.

FIG. 3A shows two waveguide cores 100 with constant width according to an embodiment of the disclosed technology and two conventional waveguide cores with constant width.

FIG. 3B shows a conventional waveguide core with varying width and a waveguide core 100 with varying width according to an embodiment of the disclosed technology.

FIG. 3C shows a respective measured insertion loss for exemplary waveguide cores 100 with constant width according to an embodiment of the disclosed technology.

FIG. 3D shows a respective measured insertion loss for exemplary waveguide cores 100 with varying width according to an embodiment of the disclosed technology.

A varying width of the waveguide core 100 Wₘₐₓ may be achieved by varying the parameter θ_{c} for the inner edge or boundary while fixing the parameter θ_{c} for the outer edge or boundary. Alternatively, the θ_{c} for the inner boundary and the θ_{c} for the outer boundary may be varied. The waveguide may be fabricated on a SiN with Silicon oxide as the bottom and upper cladding. The thickness of SiN may be 150 nm, the width in WG₁ and WG₂ may be 0.5 μm, and the light wavelength may be 638 nm.

Conventionally, waveguide cores 100 associated with oval-circular curves may be used to widen the waveguide to excite a WGM. For example, a circular curve as the outer boundary of the bend, and an oval curve as the inner boundary of the bend may be used. However, the usage of such conventionally waveguide cores 100 is limited to a maximal 180° bend, and have a straight-bent transition loss.

The waveguide core 100 and/or the bend of the waveguide core 100 may excite a WGM adiabatically, for example, by giving the inner and outer boundary of the waveguide core 100 different θ_{c} values. If a WGM is excited in the waveguide core 100, a heater, for example, a doped silicon heater, can be embedded into the bend of the waveguide core 100 which can significantly improve the energy efficiency of a thermo-optic phase shifter including the heater. For conventional thermo-optic phase shifters, the heater may be placed on top of the waveguide.

Doped Si may be used as a heater to improve the energy efficiency. This may be more efficient because Si has, for example, more than 100× higher thermal conductivity than SiO₂. When the heating is generated in the waveguide, most of the heating may propagate along the longitudinal extension of the waveguide core. A waveguide core 100 according to an embodiment of the disclosed technology may enable and/or be connectable to a whispering gallery mode-based (WGM-based) doped Si heater.

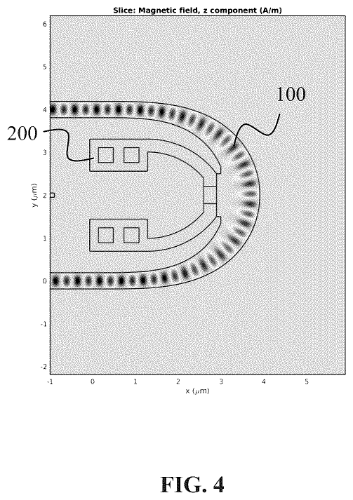

FIG. 4 shows a top-view of a thermo-optic phase shifter 200 for regulating a temperature of a waveguide core 100 that is configured to excite a WGM according to an embodiment of the disclosed technology.

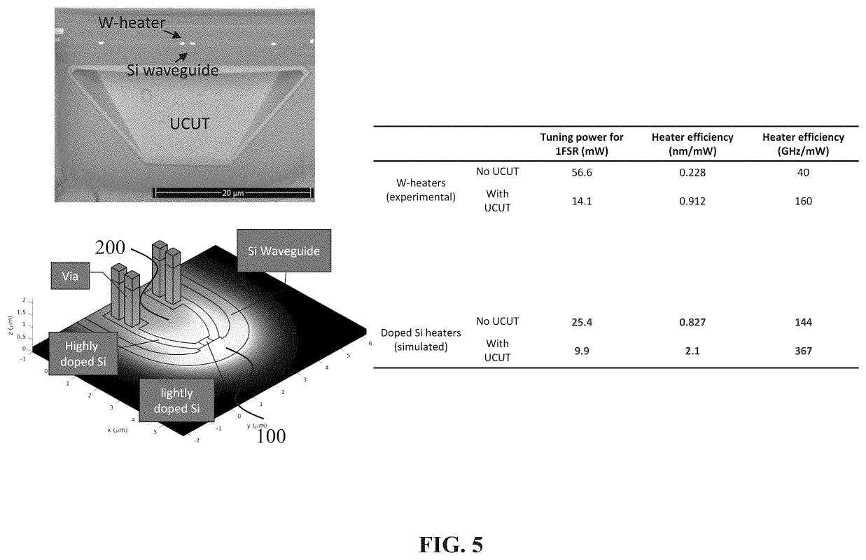

FIG. 5 shows an energy efficiency comparison of a conventional Tungsten (W) heater and a WGM-based heater according to an embodiment of the disclosed technology.

The WGM-based heater may be a thermo-optic phase shifter 200 or may be included in a thermo-optic phase shifter 200.

The disclosed technology has been described in conjunction with various embodiments as examples as well as implementations. However, other variations can be understood and effected by those persons skilled in the art. The word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A waveguide core having a smooth curve as an edge and/or centerline of the waveguide core,
wherein a curvature of the smooth curve is continuous and the first order derivative of the curvature of the smooth curve with respect to an arc length of the smooth curve is continuous,
wherein the smooth curve comprises a curve start point and a curve end point,
wherein the derivative of the curvature of the smooth curve is zero at the curve start point and at the curve end point, and
wherein the curvature of the smooth curve is zero at the curve start point, and is non-zero or zero at the curve end point.

2. The waveguide core according to claim 1, wherein the smooth curve comprises a curve segment,
wherein the curve segment comprises a start point of the curve segment and an end point of the curve segment,
wherein the derivative of the curvature of the smooth curve is zero at the start point of the curve segment and is zero at the end point of the curve segment, and
wherein the curvature of the smooth curve is zero at the start point of the curve segment and is non-zero at the end point of the curve segment.

3. The waveguide core according to claim 2, wherein a Cartesian coordinate system is defined with the start point of the curve segment as its origin,
wherein the x-axis and y-axis are defined to have the end point of the curve segment in the first quadrant, and a tangential angle of zero radian at the start point of the curve segment, and
wherein the tangential angle of any point P on the curve segment is
$$θ ( s ) = \frac{4 {κ}_{e}^{3} {θ}_{e} {s}^{3} - {κ}_{e}^{4} {s}^{4}}{16 {θ}_{e}^{3}} ,$$
wherein s is the length of the arc length of the smooth curve from the start point of the curve segment to a point P, wherein κₑ is the curvature at the end point of the curve segment, and θₑ is the tangential angle at the end point of the curve segment.

4. The waveguide core according to claim 2, wherein the curve segment of the smooth curve is parallel to a baseline curve,
wherein the baseline curve comprises a start point of the baseline curve and an end point of the baseline curve,
wherein a Cartesian coordinate system is defined with the start point of the baseline curve as its origin,
wherein the x-axis and y-axis are defined to have the end point of the baseline curve in the first quadrant, and a tangential angle of zero radian at the start point of the baseline curve, and
wherein the tangential angle of any point P on the baseline curve is
$$θ ( s ) = \frac{4 {κ}_{e}^{3} {θ}_{e} {s}^{3} - {κ}_{e}^{4} {s}^{4}}{16 {θ}_{e}^{3}} ,$$
wherein s is the length of the arc length of the smooth curve from the start point of the baseline curve to a point P, wherein κₑ is the curvature at the end point of the baseline curve, and θₑ is the tangential angle at the end point of the baseline curve.

5. The waveguide core according to claim 2, wherein the smooth curve further comprises a straight segment,
wherein the straight segment comprises a start point of the straight segment and an end point of the straight segment, and
wherein the end point of the straight segment is connected to the start point of the curve segment.

6. The waveguide core according to claim 2, wherein the smooth curve further comprises a circular segment,
wherein a curvature of the circular segment is constant,
wherein the curvature of the circular segment is equal to the curvature of the smooth curve at the end point of the curve segment,
wherein the circular segment comprises a start point of the circular segment and an end point of the circular segment, and
wherein the end point of the curve segment is connected to the start point of the circular segment.

7. The waveguide core according to claim 2, wherein the curve segment is a first curve segment and wherein the smooth curve further comprises a second curve segment according to the first curve segment,
wherein the curvature at the end point of the first curve segment is the same as the curvature at the end point of the second curve segment, and
wherein the end point of the first curve segment is connected to the end point of the second curve segment, or wherein the end point of the circular segment is connected to the end point of the second curve segment.

8. The waveguide core according claim 1, the waveguide core having a first smooth curve as an inner edge and/or centerline of the waveguide core, and having a second smooth curve as an outer edge of the waveguide core.

9. The waveguide core according to claim 8, wherein the first smooth curve and the second smooth curve are parallel to each other.

10. The waveguide core according to claim 8, wherein the first smooth curve and the second smooth curve are not parallel to each other.

11. The waveguide core according to claim 8, wherein the waveguide core is configured to be thermally connectable to a thermo-optic phase shifter in at least a portion of the inner boundary of the waveguide core.

12. The waveguide core according to claim 11, wherein a sidewall of the waveguide core facing towards the thermo-optic phase shifter in the at least the portion of the inner boundary is configured to be open for the thermo-optic phase shifter.

13. The waveguide core according to claim 8, wherein a centerline of the waveguide core along the longitudinal extension of the waveguide core defines a plane, and
wherein the inner edge of the waveguide core and the outer edge of the waveguide core are in the plane along the longitudinal extension of the waveguide core.

14. The waveguide core according to claim 1, wherein the waveguide core is configured to excite a whispering gallery mode.
